(19) United States
(12) Patent Application Publication
(10) Pub. No.: US 2004/0082203 A1
(43) Pub. Date: Apr. 29, 2004

(54) Method and apparatus for power theft prevention based on TDR or FDR signature monitoring on LV and MV power lines

(76) Inventors: Oleg Logvinov, East Brunswick, NJ (US); Brion J. Ebert, Easton, PA (US)

Correspondence Address: Lorimer P. Brooks, Esq., Norris, McLaughlin & Marcus, P.O. Box 1018, Somerville, NJ, 08876-1018, US

(21) Appl. No.: 10/431,214

(22) Filed: May 7, 2003

Related U.S. Application Data
(60) Provisional application No. 60/378,601, filed on May 7, 2002.

(51) Int. Cl. H01R 39/00

(52) U.S. Cl. 439/10

(57) ABSTRACT

Method and apparatus for detecting an authorized tap on an electrical power line in which electrical reflectometry signals are supplied to a portion of the power line by a transmitter, reflected such signals are received from the power line by a receiver and the reflected signals are compared in a comparator with signals reflected by authorized taps on the power line to determine whether or not unauthorized taps are present. In a preferred embodiment, the transmitter and receiver are part of power line communication apparatus and, if desired, such apparatus can transmit signals indicating tap changes to a remote control center.

### RELATED APPLICATIONS

Benefit of provisional application Serial No. 60/378,601, filed May 7, 2002 and in the names of the inventors named herein is claimed and such application is incorporated herein by reference. The disclosure of copending application Ser. No. filed May 6, 2003 and entitled Method and System for Power Line Network Fault Detection and Quality Monitoring is also incorporated herein by reference.

### FIELD OF THE INVENTION

The present invention relates to the field of monitoring electrical power distribution networks using an apparatus capable of performing a TDR (Time Domain Reflectometry) or FDR (Frequency Domain Reflectrometry) analysis to monitor a power distribution network and detect any changes to the TDR or FDR signature of the network as a result of a change to the network topology. Any change can then be verified by the owner of the network to determine if there has been any unauthorized tap of electrical power.

### BACKGROUND OF THE INVENTION

There exist today electrical power distribution networks throughout the entire world. The electrical power network reaches more homes and businesses than any other network, wired or wireless. The use of electrical power is a large part of everyday life for most people. Because electrical power is so important, electric power provider companies are constantly looking for ways to monitor, regulate, and improve their power distribution networks. Most power utilities already monitor the level of use of power on their networks, and some are able to control and adjust based on the power load. However, this monitoring is done on a gross scale, and is used to manage and control the network as a whole. The actual amount of power used by any one customer is recorded, and therefore, billed by, the use of electrical meters installed at the customer end of the network. Because it is difficult for power utilities to monitor the use of its power on a small scale, it is possible for electrical power to be tapped off of a distribution network, on the network side of any meters, without the utility company being aware. This application describes a method and apparatus for detecting these unauthorized taps.

### BACKGROUND OF THE INVENTION

Power line communication (PLC) systems are well known in the art. See, for example, Chapter 6 of the book entitled “The Essential Guide to Home Networking Technologies” published in 2001 by Prentice-Hall, Inc., copending U.S. application Ser. Nos. 09/290,255, filed Apr. 12, 2000, 10/211,033 filed Aug. 2, 2002 and 10/309,567, filed Dec. 4, 2002, the web site http:/www/houseplug.org of the Home Plug Special Interest Group and page 42 of the Communications International Magazine, March 2000.

TDR and FDR systems are well known in the art. See, for example, the article entitled “Loop Makeup Identification Via Single Ended Testing: Beyond Mere Loop Qualification” in the IEEE Journal on Selected Areas in Communications, Vol. 20, No. 5, June 2002 and U.S. Pat. Nos. 6,532,215; 6,504,793 and 6,466,649.

The basic concept used to be able to detect these changes in network characteristics is TDR. Time Domain Reflectometry was originally developed to be able to test the integrity of cables and locate faults. The network analysis can be performed through either conventional TDR, or FDR (Frequency Domain Reflectometry), which is more suitable for DSP chains. Both methods produce similar TDR like signatures of the network under examination. TDR works on the same principle as radar. A pulse of energy is transmitted down a cable. When that pulse reaches the end of the cable, or a fault along the cable, part or all of the pulse energy is reflected back to the instrument. TDR measures the time it takes for the signal to travel down the cable, see the problem, and reflect back. TDR then converts this time to distance and displays the information as a waveform and/or distance reading.

This process can also be done on a network of cables. Time Domain Reflectometry can be used on any conductor (wire, cable, or fiber optic) by sending a pulsed signal into the conductor, and then examining the reflection of that pulse. By examining the polarity, amplitude, frequencies and other electrical signatures of all reflections; any tampering may be precisely located.

Frequency Domain Reflectometry is basically an extension of conventional TDR where the test apparatus is stimulating the line with a linearly stepped frequency sinusoidal waveform, this produces a composite waveform response which, when subjected to frequency domain reflectometry analysis, yields distance data representative of locations of the energy reflection anomalies.

Any device or wire attached will cause a detectable anomaly, and a physical inspection at the location of the anomaly can then be performed. By installing a TDR or FDR measurement apparatus on a power line network and monitoring any changes in the characteristic response, a change to the network, can be detected. This information can then be relayed to the power utility to determine if the change was authorized.

When looking at a common power transmission network, it can be broken up into three (3) main segments. From a standard power substation, there is commonly a network of medium voltage power lines, configured in a loop and several miles in length that feed out to an area of homes and businesses. Then at various points on the loop, there exist step down transformers that provide a series of 110-240 V lines depending on the country to a small number of homes and/or businesses. At the end of each one of these lines, there is typically a meter or meters present for each electricity customer served by that line. The TDR or FDR signal monitor can be installed at various locations along the network, depending on desired use. In power line networks where a PLC (Power Line Communication) system is installed, the TDR or FDR signal monitor can be a part of the same equipment used for power line communication.

The signature or characteristics of electrical energy reflected from a tap on a power line differs from the signature or characteristics of energy reflected by other variations in the power line impedance, e.g. reflections from the open end of a line, a break in the line, a component in series with the line, etc. Therefore, the reflected energy can be analyzed and taps on the line, both authorized and unauthorized, can be identified.

### BRIEF SUMMARY OF THE INVENTION

Using TDR or FDR equipment, electrical energy is supplied to a MV (medium voltage) or LV (low voltage) power line and the reflected energy is analyzed and compared with an analysis previously made of the reflections when the power line is correctly connected and operational and is without any unauthorized taps. When the comparison indicates that there is an unauthorized tap, the location of the unauthorized tap is noted from the data and appropriate action is taken, such as physically finding the unauthorized tap, removing it and taking action with respect to the installer of the unauthorized tap.

When power line communication (PLC) equipment is to be installed on the power line, either as original equipment or replacement equipment, it is preferred that the TDR or FDR equipment be included in the power line communication equipment so that components of the PLC equipment can be used with the TDR and FDR components, e.g. the transceiver and controls of the PLC equipment can be used for transmitting and receiving the TDR or FDR signals and for coordinating and separation of the various signals. Furthermore, if the TDR or FDR signals on their analyses are to be transmitted to equipment at a point remote from the point at which the TDR or FDR equipment is located, e.g. to a control center or power company plant, such signals, analyses or an alarm signal can be transmitted to the remote point over the power lines by the PLC equipment.

### BRIEF DESCRIPTION OF THE FIGURES

The present invention will be subsequently described further with reference to the accompanying drawings in which:

FIG. 1 depicts a typical TDR response from a tested cable;

FIG. 2 shows the TDR response from a cable with a number of taps;

FIG. 3 shows various scenarios of a power line network with a TDR or FDR enabled PLC system installed;

FIG. 4 is a block diagram of a PLC (Power Line Communication) apparatus which incorporates reflectometry apparatus.

### DETAILED DESCRIPTION

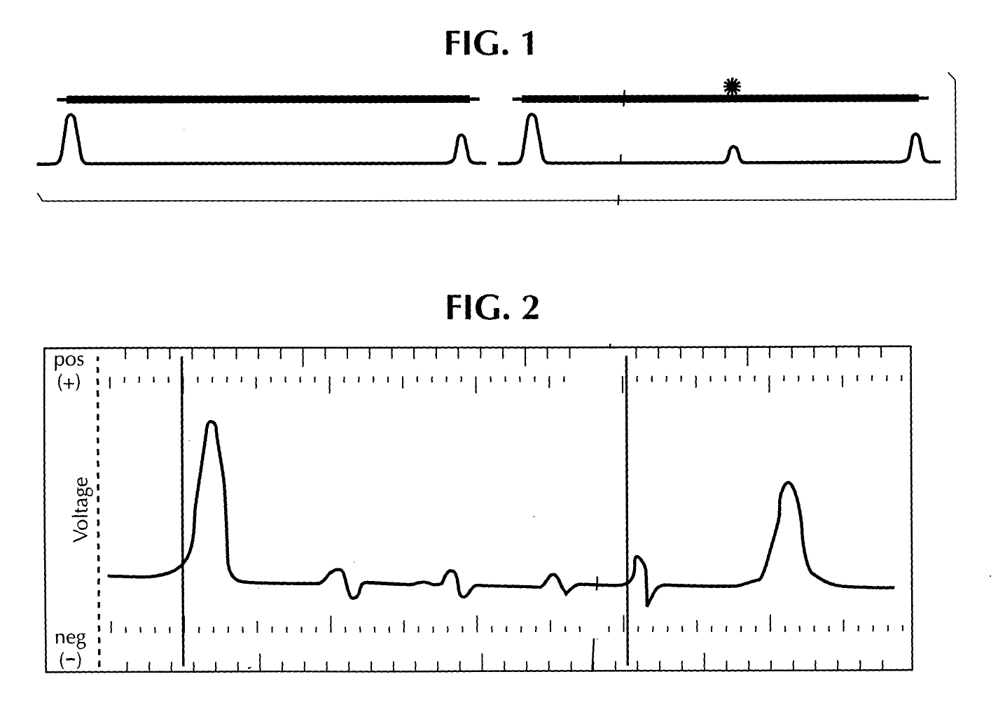

FIG. 1 illustrates a typical response from a TDR measurement performed on a cable. As is shown, a reflection will be seen at a point where the cable is damaged, and also at the end of the cable where it is open. The time it takes to see the reflections can be used to determine how far down the cable the problem exists.

FIG. 2 shows a TDR response from a cable that has a number of taps. Again the time between the reflections will determine the location of the taps. This particular scenario shows a number of equally spaced taps, with each reflection getting smaller in amplitude due to cable loss. The larger reflection beyond the smaller ones may indicate an undetermined or faulty tap. If this reflection had not been seen during previous monitoring, this would indicate a new tap that may not be very secure. The power utility or the owner of the network could then be informed of this change.

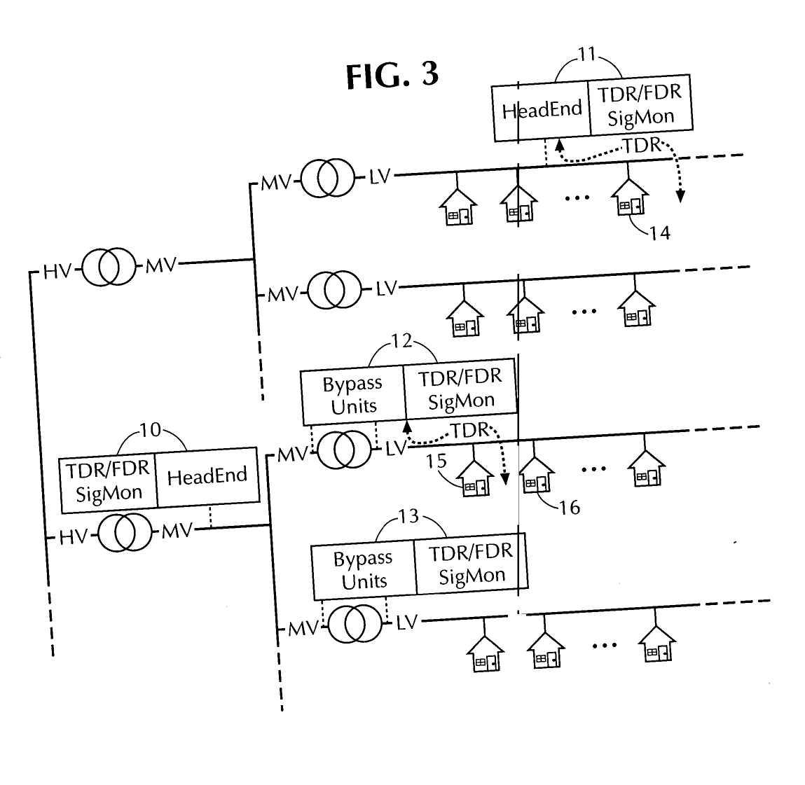

In FIG. 3, the various segments of a typical power line network are schematically shown. The overlapping circles represent transformers. Also shown are various device installation points for TDR/FDR enabled PLC devices. Devices can be installed on both a Medium Voltage (MV) and a Low Voltage (LV) power line network segment, comprising together a single logical PLC network. Bypass units are shown as parts of TDR/FDR SigMon (signal monitor) devices 12 and 13 that allow for communication to continue around step-down transformers that exist between the MV and LV network segments. Each home shown also has a Gateway communication device, of which 3 are designated in FIG. 3 as 14, 15 and 16, as part of the PLC system. Monitoring can be done from the Headend TDR/FDR SigMon units 10 and 11, the Bypass TDR/FDR SigMon units 12 and 13, and the Gateway units 14, 15, 16. An important point to note here is that monitoring can be done from both ends of a network segment, which is important for TDR/FDR measurements. A more detailed analysis can be done by comparing the responses from both ends of a segment. As shown in FIG. 3, monitoring of the same segment can be done from unit 11 and from unit 14, or from unit 12 and unit 15 and unit 16, or from unit 10, and unit 12, and unit 13, which in each scenario would give similar but slightly different responses, and allow for additional comparison and analysis to be completed. Based on the installation points, various sections of the power line network can be monitored with both TDR and FDR analysis. The obvious advantage here is that one system can be used for both data communication and network monitoring for theft prevention. In addition, any changes to the network detected by monitoring can be communicated to a desired point using the same data communication link.

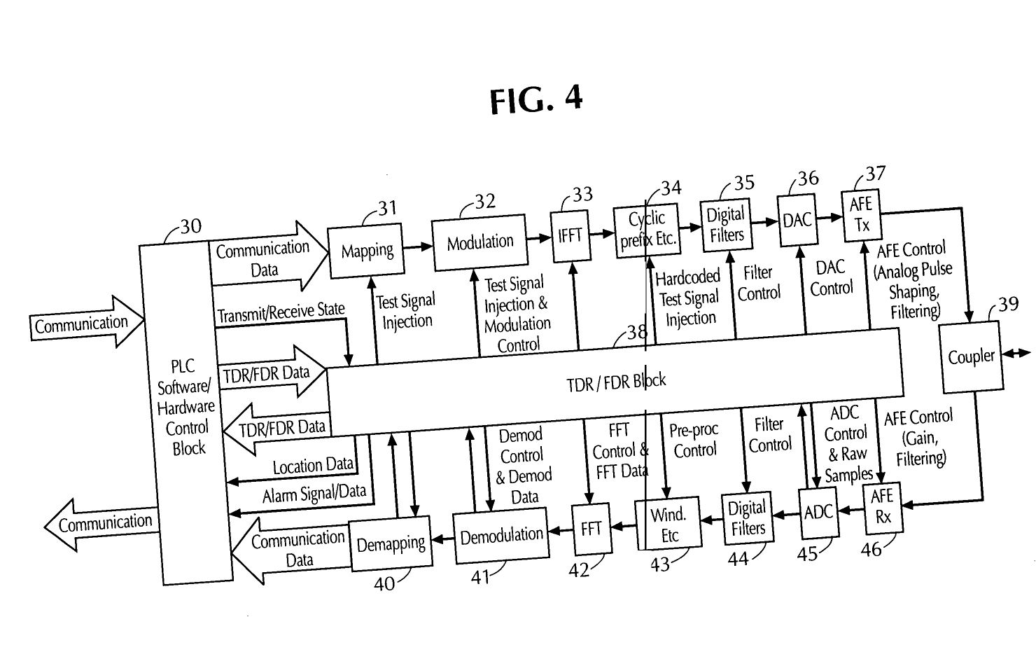

FIG. 4 illustrates a preferred embodiment of the invention in which the reflectometry apparatus is combined with PLC apparatus. As is known in the prior art, and described in the patents and applications and publications referred to hereinbefore, there exists a PLC system, comprising a chain of transmitter DSP blocks and a chain of receiver DSP blocks and a central controller block that interfaces to each DSP block with control and parameter information, to successfully transmit and receive data signals across a power line. The transmitter DSP chain comprises a Mapping block 31, a Modulation block 32, an IFFT (Inverse Fast Fourier Transform) block 33, a Cyclic Prefix block 34, a Digital Filters block 35, a DAC (Digital to Analog Converter) block 36, and a Tx AFE (Transmit Analog Front End) block 37. The receiver DSP chain consists of an Rx AFE (Receive Analog Front End) block 46, an ADC (Analog to Digital Converter) block 45, a Digital Filters block 44, a Window block 43, an FFT (Fast Fourier Transform) block 42, a Demodulation block 41, and a Demapping block 40. The PLC Software/Hardware Control Block 30 interfaces with each of the transmitter and receiver DSP blocks with control and parameter information by conventional connections (not shown), as known in the prior art. The PLC Software/Hardware Control Block 30 takes data for transmission and processes it through the transmit DSP chain, with control and parameter information, to convert the data to analog signals that are sent on the Powerline through the Coupler 39, as is known in the prior art. Similarly, analog signals are received through the Coupler 39, and processed through the receive DSP chain, with control and parameter information from the PLC Software/Hardware Control Block 30, to arrive at received data, as is known in the prior art. In a preferred embodiment of the invention, a TDR/FDR Block 38 is added, which also has interfaces with the transmitter and receiver chain DSP blocks. The existing DSP blocks of a prior art PLC system are utilized, with the addition of a TDR/FDR Block 38, to transmit and receive TDR and FDR test signals onto the Powerline network during the moments of time when there are no normal PLC data communication events occurring. The device can be configured to either transmit, and receive a response from, a nearly instantaneous, or spike of energy (TDR), or transmit, and receive a response from, a predefined set of sine waves representing a test signal with preprogrammed energy levels over a range of carrier frequencies (FDR).

During non-PLC, or silent periods, of a Powerline network, the TDR or FDR test signals are generated, and inserted into the PLC transmit processing chain by the TDR/FDR Block 38, depending on the type of test signal that is desired to be used. The TDR/FDR Block 38 is aware of when the silent periods are, based on information it receives from the PLC Software/Hardware Control Block 30 about the current transmit/receive state. Different types of test signals can be utilized, depending on the type of test being performed, and the particular characteristics of a Powerline network. For example, a hard coded test signal can be used directly from the TDR/FDR Block 38 to perform routine or standard tests, or a custom signal can be generated and synthesized, through the use of the transmit DSP blocks, to perform a more specialized test depending on the particular characteristics of a network segment, or, for example, to determine the particular type of anomaly that may have occurred on a network segment, to determine or confirm that a new tap has occurred. This signal is then transmitted onto the Powerline through the Coupler 39. On the receive side, a transmitted test signal, or the reflected network signature response from a transmitted signal, is received through the Coupler 39, or detected and received, by the PLC receive DSP chain, and then is processed through the PLC receive DSP chain, depending on the type of signal. The signal or signal response is then analyzed by the TDR/FDR Block 38 with an eye toward detecting any change in the network response signature or network characteristics that would be representative of a change in topology that may indicate a new, unauthorized tap onto the network, and determine the location of the possible new tap. In general, this can be accomplished by comparing the current network response signature with an initial network response signature that would have been determined and/or characterized at the time of installation of the invention-enabled PLC device, and stored in its memory. As mentioned previously, once it has been determined that a change has occurred, a more specialized test signal can be generated, transmitted, and the signal or the reflected response can be received, to determine or confirm that the change is a new tap on the network.

When the TDR/FDR Block 38 detects a change in the network signature response, and determines the location of this change, this information, which may be TDR/FDR response data, location data, alarm signals or data, or any combination thereof, will be exchanged with the existing PLC Software/Hardware Control Block 30 of the PLC device. The PLC Software/Hardware Control Block 30, which has conventional connections (not shown) to the transmit and receive DSP chain blocks for normal PLC data transmission, as is known in the prior art, will then format this information into a normal PLC transmission, and then transmit the data down the Powerline, through the Coupler 39, to another PLC device at another location in the network. This information may then be transmitted to yet another PLC device, or this and other similar detection data may be collected at this PLC device. Ultimately, in the preferred embodiment, there will be a central point in the Powerline network, for example, a head end PLC unit, where theft detection data is collected and presented to the managing entity of the network, for example, an electric utility, who will use the information to investigate the detected location or locations for power theft. In a multi-node system, the ability to share data among multiple nodes may be used to improve the accuracy of the measurements and operation of the system as the whole. The information that is gathered by means of the proposed method can be shared among all of the nodes in the system or network. In these cases, it becomes possible to use this information to narrow down in cases where a more precise measurement is needed.

Such system with TDR/FDR analysis may be performed in a centralized component of the system or network that may be residing on one of the nodes, a head end unit as an example. Or in the different version of the preferred embodiment, such intelligence may be distributed across multiple nodes in the system.

Although preferred embodiments of the present invention have been illustrated and described, it will be apparent to those skilled in the art that various modifications may be made without departing from the principles of the invention.

What we claim is:

1. A method of detecting an unauthorized tap on an electrical power line which supplies electrical power for electrical apparatus at the premises of electrical power consumers, said method comprising:
supplying electrical reflectometry signals to a portion of the power line;
receiving reflectometry signals from the power line which have been reflected by taps on the power line; and
comparing the received reflected signals with reflected signals reflected by authorized taps on the power line to determine whether or not unauthorized taps are present on the power line.

2. The method as set forth in claim 1 wherein the reflectometry signals are time domain reflectometry signals.

3. The method as set forth in claim 1 wherein the reflectometry signals are frequency domain reflectometry signals.

4. The method as set forth in claim 1 wherein the reflected reflectometry signals indicate the locations of the taps with respect to the portion of the power line to which the reflectometry signals are supplied.

5. The method as set forth in claim 1 further comprising transmitting information about the reflected signals to a first power line communication apparatus disposed at a point remote from said portion of the power line by a second power line communication apparatus coupled to the portion of the power line and controllable by the received reflected signals for transmitting information about the reflected signals from the second power line communication apparatus to the first power line communication apparatus.

6. The method as set forth in claim 1 wherein electrical reflectometry signals are also supplied to another portion of the power line to provide further information about the reflected signals.

7. Apparatus for detecting an unauthorized tap on an electrical power line which supplies electrical power for electrical apparatus at the premises of electrical power consumers, said apparatus comprising:
a reflectometry signal transmitter for supplying reflectometry signals to the power line;
a reflectometry signal receiver for receiving reflectometry signals reflected by taps on the power line;
a comparator coupled to the receiver for comparing the signals reflected by the taps with signals previously reflected by taps on the power line and for providing a change signal output when the signals reflected by the taps change.

8. Apparatus as set forth in claim 7 wherein the transmitter and the receiver are, respectively, the transmitter and receiver of a power line communication apparatus for transmitting and receiving communication data.

9. Apparatus as set forth in claim 8 wherein the power line transmitter is coupled to the comparator for supplying to the power line data signals corresponding to the change signal.
